(19) United States
(12) Patent Application Publication
(10) Pub. No.: US 2008/0050110 A1
(43) Pub. Date: Feb. 28, 2008

(54) Method for adjusting a mechanical shutter

(76) Inventors: Tai-Hsin Liu, Taipei City (TW); Pao-Ming Shih, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,977

(22) Filed: Aug. 24, 2006

(51) Int. Cl. G03B 7/093

(52) U.S. Cl. 396/246

(57) ABSTRACT

A method for adjusting a mechanical shutter when an exposure time of the mechanical shutter is less than a control time of the mechanical shutter, including: (a) measuring a raw image of an initial photo to obtain a standard brightness value, after the initial photo with a predetermined correct luminance is captured in a high luminance environment; (b) fixing some parameters that are changed easily when taking a picture, after auto exposure (AE) is stable; (c) adjusting the mechanical shutter's trigger point; (d) taking a picture for obtaining another photo and measuring a raw image of the other photo for obtaining a testing brightness value; (e) comparing whether the testing brightness value and the standard brightness value are the same; and (f) if the testing brightness value and the standard brightness value are the same, determining that the trigger point is a real trigger point of the mechanical shutter.

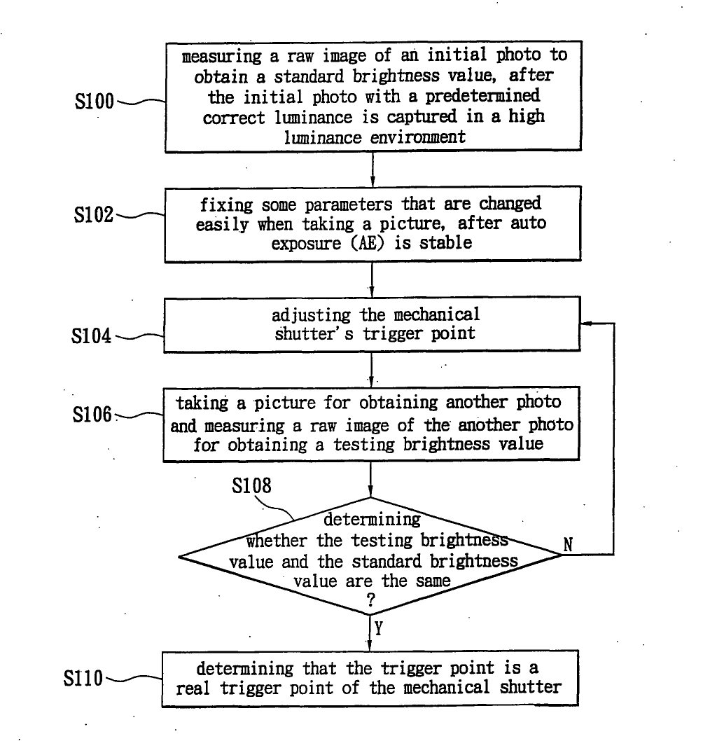

### BACKGROUND OF THE INVENTION

1. Field of The Invention

The present invention relates to a method for adjusting a mechanical shutter, and particularly relates to a bright environment (above LV (Light Value) 15) and a method for adjusting the mechanical shutter when the exposure time of the mechanical shutter is less than the control time of the mechanical shutter.

2. Description of the Related Art

There are many methods for people to commemorate an occasion. One common way is by taking pictures, because any occasion such as travel, a celebration, an event or any good time that deserves to be commemorated can be recorded via a camera. Moreover, it is convenient for users to transmit image data from the camera to an electronic device such as a computer for modifying the image data. In addition, the price of a camera has become increasingly cheaper, so the number of people using digital cameras increases day by day.

In general, the exposure time is very short when the brightness is above LV 15. Hence, when a mechanical shutter of the camera is controlled inexactly it causes the mechanical shutter to close too quickly, exposing the picture for an insufficient amount of time. Alternatively, when the mechanical shutter is closed too slowly, the picture is overexposed. However, because standard adjusting methods for the mechanical shutter is in a DNP (Direct Numerical Procedure) lamp box (LV 12.5), the adjusted brightness value is usually incorrect in high brightness. Because the exposure time of the mechanical shutter is less than a control time of the mechanical shutter, the picture is exposed insufficiently or overexposed.

### SUMMARY OF THE INVENTION

The present invention provides a method for adjusting a mechanical shutter when the exposure time of the mechanical shutter is less than the control time of the mechanical shutter. The method of the present invention uses LV 15 as brightness standard, so that an adjusted brightness value is correct in high brightness. Hence, a user can obtain pictures with correct brightness in a bright environment (above LV 15).

In other words, insufficient exposure or overexposure does not happen in high brightness. Hence, the present has some advantages as follows:

1. The user can obtain pictures with correct brightness in the high brightness (above LV 15); and

2. The user can obtain pictures with increased quality in the high brightness (above LV 15).

One aspect of the present invention is a method for adjusting the mechanical shutter when the exposure time of the mechanical shutter is less than the control time of the mechanical shutter. The method comprises: (a) measuring a raw image of an initial photo to obtain a standard brightness value, after the initial photo with a predetermined correct luminance is captured in a high luminance environment; (b) fixing some parameters that are easily changed when taking a picture, after auto exposure (AE) is stable; (c) adjusting the mechanical shutter's trigger point; (d) taking a picture for obtaining another photo and measuring a raw image of the another photo for obtaining a testing brightness value; (e) determining whether the testing brightness value and the standard brightness value are the same; and (f) if the testing brightness value and the standard brightness value are the same, determining that the trigger point is the real trigger point of the mechanical shutter.

Moreover, if the testing brightness value and the standard brightness value are different, repeating the steps from (c) to (e) until the testing brightness value and the standard brightness value are the same for obtaining the real trigger point of the mechanical shutter.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

The FIGURE is a flow chart of a method for adjusting a mechanical shutter (when the exposure time of the mechanical shutter is less than the control time of the mechanical shutter) of the present invention.

### DETAILED DESCRIPTION OF PREFERRED BEST MOLDS

Referring to the FIGURE, the present invention provides a method for adjusting a mechanical shutter when an exposure time of the mechanical shutter is less than a control time of the mechanical shutter. The steps of the method comprise: measuring a raw image of an initial photo to obtain a standard brightness value, after the initial photo with a predetermined correct luminance is captured in a high luminance environment (S100). The high luminance environment has a brightness value between LV (Light Value) 15 and LV 16, and the predetermined correct luminance is 128 LM (lumen).

Moreover, the method further comprises: fixing some parameters that are changed easily when taking a picture, after auto exposure (AE) is stable (S102). In addition, the AE is a built-in automatic diaphragm control program. Because a camera can automatically adjust a size of a diaphragm of the camera according to different brightness, a user only needs to aim at an object when taking a picture. Furthermore, the parameters can be exposure time and auto gain control (AGC). The AGC is started when the camera senses the brightness is insufficient to increase a light level of a photo.

In addition, the method further comprises: adjusting the mechanical shutter's trigger point (S104); taking a picture for obtaining another photo and measuring a raw image of the another photo for obtaining a testing brightness value (S106); determining whether the testing brightness value and the standard brightness value are the same (S108); and if the testing brightness value and the standard brightness value are the same, determining that the trigger point is a real trigger point of the mechanical shutter (S110).

Furthermore, if the testing brightness value and the standard brightness value are different, repeating the steps from S104 to S108 until the testing brightness value and the standard brightness value are the same for obtaining the real trigger point of the mechanical shutter. In other words, if the testing brightness value and the standard brightness value are different, proceeding with the steps of adjusting the mechanical shutter's trigger point, taking a picture for obtaining another photo and measuring a raw image of the another photo for obtaining a testing brightness value and comparing whether the testing brightness value and the standard brightness value are the same. Hence, the steps of adjusting the trigger point, obtaining a testing brightness value, and comparing the testing brightness value with the standard brightness value are repeated until the testing brightness value and the standard brightness value are the same.

The method of the present invention uses LV 15 as brightness standard, so that an adjusted brightness value is correct in high brightness. Hence, a user can obtain pictures with correct brightness in a bright environment (above LV 15). In other words, insufficient exposure or overexposure does not happen in high brightness.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for adjusting a mechanical shutter, wherein an exposure time of the mechanical shutter is less than a control time of the mechanical shutter, the method comprising:
(a) measuring a raw image of an initial photo to obtain a standard brightness value, after the initial photo with a predetermined correct luminance is captured in a high luminance environment;
(b) fixing some parameters that are changed easily when taking a picture, after auto exposure (AE) is stable;
(c) adjusting the mechanical shutter's trigger point;
(d) taking a picture for obtaining another photo and measuring a raw image of the another photo for obtaining a testing brightness value;
(e) determining whether the testing brightness value and the standard brightness value are the same; and
(f) if the testing brightness value and the standard brightness value are the same, determining that the trigger point is a real trigger point of the mechanical shutter.

2. The method as claimed in claim 1, wherein the high luminance environment has a brightness value between LV (Light Value) 15 and LV 16.

3. The method as claimed in claim 1, wherein the predetermined correct luminance is 128 LM (lumen).

4. The method as claimed in claim 1, wherein the parameters comprise exposure time and auto gain control (AGC).

5. The method as claimed in claim 1, further comprising: if the testing brightness value and the standard brightness value are different, repeating the steps from (c) to (e) until the testing brightness value and the standard brightness value are the same for obtaining the real trigger point of the mechanical shutter.
